(19) United States
(12) Patent Application Publication
(10) Pub. No.: US 2011/0062718 A1
(43) Pub. Date: Mar. 17, 2011

(54) Generator platform & drive assembly for alternative power production from aermotor and similar design windmills

(76) Inventor: Carlos Fernandez-Bueno, Dickerson, MD (US)

(21) Appl. No.: 12/585,524

(22) Filed: Sep. 17, 2009

(51) Int. Cl. F03D 9/00

(52) U.S. Cl. 290/55

(57) ABSTRACT

This invention is a unique ‘Generator Platform and Drive Assembly for Alternative Power Production from Aermotor® and Similar Design Windmills”. Used to convert or retrofit prior art water pump windmills to produce renewable energy, mainly in the form of electricity. This invention incorporates the attributes of the prior art windmill's high torque, low rpm, low wind, multiple sail design with a unique, versatile “Generator Platform and Drive Assembly’. The power from the sails is transferred and amplified by the invention's custom design ‘split’ sprocket/pulley specifically machined to attach to the Aermotor® prior art sail/brake hub, which then turns the generator attached to the ‘generator platform’, by means of a belt or chain drive. The invention's bolt-on ‘Platform and Drive Assembly’ has a unique design to specifically be able to easily retrofit a prior art water pump windmill for the production of electricity, compressed gases, hydraulic pressure, or any other form of energy which require a motor or generator. The invention's ‘generator platform’ is fitted to the windmill's, prior art, gearbox by bolts or weld. The invention's split ring pulley/sprocket allows for easy installation on the sail/brake hub. This is accomplished ‘in the field’ without having to dismantle or lower to the ground the existing windmill.

This ‘Generator Platform and Drive Assembly’ can be incorporated in the manufacture of new Aermotor® and similar design windmills which can also be used to economically replace a disabled windmill on an existing, structurally sound, tower.

### STATEMENT REGARDING FEDERALLY SPONSORED RESEARCH OR DEVELOPMENT

Not applicable.

### CROSS REFERENCE TO RELATED APPLICATIONS

Application Ser. No. 11/889,373 Filed Oct. 9, 2007.

‘Conversion kit for generating electricity from water pump windmills’.
Current invention describes a uniquely different generator platform and drive assembly from the prior description of a split ring drive assembly.

### Inventor: Carlos Fernandez-Bueno

### FIELD OF INVENTION

Relates to the conversion and or retrofit of, prior art, water pumping windmills

### BACKGROUND OF THE INVENTION

Windmills used for pumping water, like the Aermotor® and similar designs, have been in production in the U.S.A. since 1888. The sail design of these windmills is uniquely suited for very low wind applications. They usually have as many as 18 blades. The large surface area of these sails respond to very low winds and have high torque. They also rotate at very low revolutions per minute (rpm). They reach maximum output in the 20 miles per hour (mph) wind range. Sails range from 6 to 16 feet in diameter. The prior art, water pumping Aermotor®, is recognized around the world as an “American Windmill” icon. Their durability is legendary with many of them still in use 100 years after being placed in service.

In contrast, modern direct drive, small wind turbines are designed for moderate and strong wind applications. They have a relatively small exposure to the wind featuring only two or three thin blades and must rotate at very high rpm's. These turbines require winds in excess of 8-10 mph to start producing any usable form of electricity.

In the month of August, 2009, at the Potomac Wind Energy testing located in Dickerson, Md., U.S.A., two Aermotor® retrofit conversions were generating power over 80% of the time in contrast to four modern 3 bladed turbines which were generating power less than 20% of the time. The implications are tremendous since in the eastern part of the U.S.A the average wind speeds are lower than 10 mph, making modern 2 or 3 bladed turbines very ineffective and costly in terms of kilowatt power produced per dollar invested.

This invention's ‘Generator Platform and Drive Assembly’ on a 16 foot diameter, 18 sail Aermotor® windmill, starts spinning in a 2 mph breeze. Connected to a direct grid tie inverter this retrofitted windmill starts to sell electricity into the public utility grid in a 3 mph breeze and has achieved an output of 6.2 kilowatts. This is several times more output in a 10 mph wind when compared to the modern a modern three bladed, direct drive, 12 foot diameter turbine.

Hundreds, and perhaps thousands of Aermotor® and similar design windmills around the world sit idle because the well has run dry. These can be easily retrofitted to generate electricity, compressed air, hydraulic pressure or any other form of energy which require a generator, at a mere fraction of the cost of installing a brand new turbine to supply required needs. This invention's ‘Generator Platform and Drive Assembly’ can also be incorporated into the manufacture of brand new, prior art, Aermotor® and similar design windmills.

The current manufacturer of the Aermotor® windmill claims on their website that “water and electricity don't mix”. However new technology in generators, charge controllers, inverters, and transformers, in addition to this invention's platform and drive assembly, have been combined to successfully produce electricity from these retrofitted, prior art, water pump windmills in a low cost and sustainable manner.

### BRIEF DESCRIPTION OF SEVERAL VIEWS OF THE DRAWING

### Generator Platform

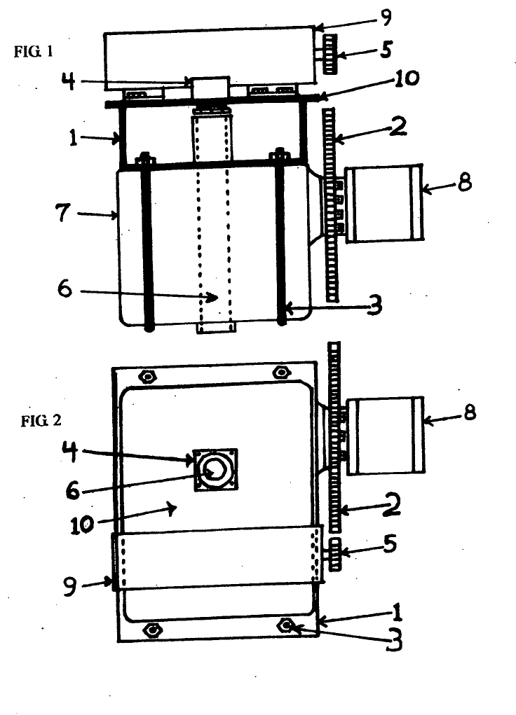

FIG. 1 SIDE VIEW

FIG. 2 TOP VIEW

### Legend for FIGS. 1 and 2

1—GENERATOR PLATFORM
2—SPLIT PULLEY
3—PLATFORM FASTENERS
4—UTILITY ACCESS PORT
5—GENERATOR PULLEY
6—TOWER MAST SHAFT
7—PRIOR ART GEARBOX
8—PRIOR ART SAIL HUB
9—GENERATOR
10—PLATFORM COVER

### DETAILED DESCRIPTION OF SEVERAL VIEWS OF THE DRAWING

### Split Ring Sprocket/Pulley Assembly

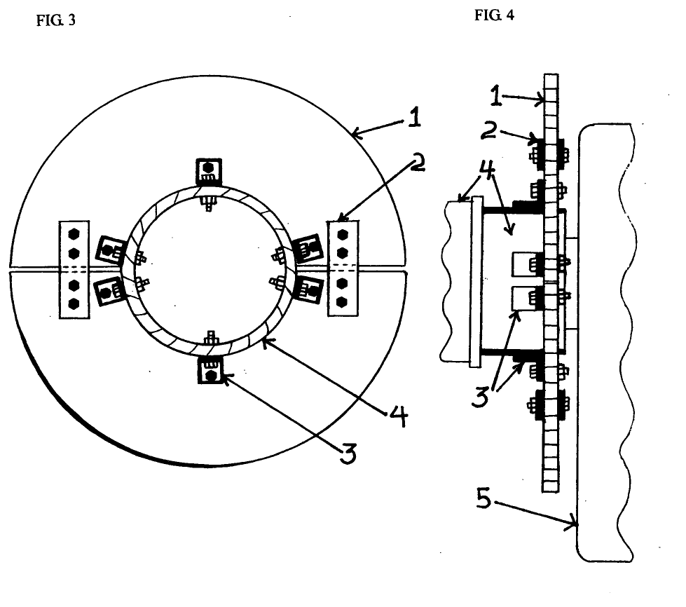

FIG. 3 FRONT VIEW

FIG. 4 SIDE VIEW

### Legend for FIGS. 3 and 4

1—SPLIT RING SPROCKET/PULLEY
2—SPLIT RING RE-ASSEMBLY PLATES
3—‘L’ FASTENING BRACKETS
4—PRIOR ART WINDMILL SAIL/BRAKE HUB
5—PRIOR ART WINDMILL GEARBOX

### DETAILED DESCRIPTION OF THE INVENTION

This invention has two basic components, A and B, manufactured from steel or similar suitable material.

A—Generator Platform. (FIGS. 1 and 2)

It provides the structural base for the assembly of all the required components. The design of this platform is unique for this particular application. It is designed and sized to specifically fit unto the upper section of the prior art gearbox of any Aermotor® or similar design windmill. This platform replaces the existing hood on the prior art windmill whose function was to protect the gearbox components from the weather. The platform provides the base onto which the generator is attached.

The platform ‘box’ is fabricated from steel ‘channel’ beam, or other suitable material, whose width must clear the height of the internal gears of the prior art gearbox. The ‘lips’ of the channel beam will be used to secure the generator and the entire platform to the prior art gearbox. The bottom of the platform box must snugly fit the outer ‘lips’ of the prior art gearbox to prevent future displacement, misalignment and vibrations of the chain/pulley drive assembly. The cover of the platform, to prevent the elements from entering the oil filled prior art gearbox, is made of steel or other suitable material. The generator is secured to the platform channel beam ‘lips’ with grade 8 bolts. The entire platform assembly is secured by bolts, clamps or weld to the existing prior art windmill gear box by means of the channel beam ‘lips’.

This platform incorporates an access port directly above the tower mast shaft to allow fastening of the prior art windmill gearbox to the tower. This access port also secures access to utility lines like electrical, compressed gas or hydraulic. These utility lines utilize the centric, hollow, tower mast shaft as a conduit.

B—Split Ring Drive Assembly. (FIGS. 3 and 4)

The inner bore of the sprocket or pulley is specifically machined to match the outside diameter of the ‘brake hub’ of the prior art Aermotor® and similar design windmills. It is a unique ‘split’ design which allows the sprocket or pulley to be bolted, clamped or welded onto the brake hub, without having to disassemble or take down the windmill prior art gearbox and sails which can weight in excess of 3,000 pounds.

The ‘brake hub’ sprocket or pulley is connected to the generator attached to the ‘platform’ by a chain or belt. The gear ratio between the sail hub and generator is easily adjusted by changing the diameter of the generator sprocket or pulley and depends on the windmill model, the diameter of the sails and the type of the generator used and matched to the specific application requirements. If incorporated into the manufacture of a new, prior art, windmill this sprocket or pulley can be installed on the brake/sail hub as an intact (not split) unit.

1. What I claim as my invention is that this is the first unique ‘generator platform and drive assembly’ specifically designed to convert or retrofit prior art windmills, like the Aermotor® and similar design, for alternative power production: This invention takes the advantages of prior art windmills which are designed for water pumping applications. These prior art windmills, which provide low rpm and high torque, are particularly suited to respond to very low wind conditions because of their average 18 blade configuration.
The invention's ‘generator platform and split ring drive assembly’ allows for the retrofit conversion of prior art windmills, without disassembly of the prior art gearbox or sails. The invention's entire assembly can be installed, in the field, using bolts, clamps or weld, without having to lower the windmill from its tower.
The invention's ‘platform’ versatility allows for several generator options. The generator may be for the production of electricity, compressed gas, hydraulic pressure, or any other power source requiring a generator or motor, chosen to meet the specific application requirements.
This invention's ‘generator platform and drive assembly’ may also be incorporated into the manufacture of new, prior art windmills, like the Aermotor® or similar designs.
